(19) United States
(12) Patent Application Publication
(10) Pub. No.: US 2026/0066430 A1
(43) Pub. Date: Mar. 5, 2026

(54) POWER STORAGE DEVICE

(71) Applicant: TOYOTA JIDOSHA KABUSHIKI KAISHA, Toyota-shi (JP)

(72) Inventors: Shigeyuki INOUE, Toyota-shi (JP); Kazuki SUGIE, Miyoshi-shi (JP); Kazuya KUMAZAWA, Nagoya-shi (JP); Kotaro HORIGUCHI, Toyota-shi (JP)

(73) Assignee: TOYOTA JIDOSHA KABUSHIKI KAISHA, Toyota-shi (JP)

(21) Appl. No.: 19/241,882

(22) Filed: Jun. 18, 2025

(30) Foreign Application Priority Data
Aug. 29, 2024 (JP) 2024-147188

(51) Int. Cl. H01M 50/249; H01M 50/209; H01M 50/264; H01M 50/271; H01M 50/289

(52) U.S. Cl. CPC H01M 50/249; H01M 50/264; H01M 50/271; H01M 50/289; H01M 50/209

(57) ABSTRACT

A power storage device includes a plurality of power storage cells arranged in a first direction, an upper cover disposed above the power storage cells, an adhesive member that bonds the power storage cells and the upper cover to each other, and an intervention member made of rubber and interposed between the power storage cells and the upper cover. The intervention member includes a pair of intervention portions extending in the first direction and disposed at positions sandwiching the adhesive member in a second direction orthogonal to both the first direction and an up-down direction. Each intervention portion is provided with an intervention space extending in the first direction.

### CROSS-REFERENCE TO RELATED APPLICATION

This application claims priority to Japanese Patent Application No. 2024-147188 filed on Aug. 29, 2024. The disclosure of the above-identified application, including the specification, drawings, and claims, is incorporated by reference herein in its entirety.

### BACKGROUND

### 1. Technical Field

The present disclosure relates to a power storage device.

### 2. Description of Related Art

For example, Japanese Unexamined Patent Application Publication (Translation of PCT Application) No. 2022-525014 (JP 2022-525014 A) discloses a power battery pack including a plurality of unit cells and a housing device. A module top plate having a cooling structure is disposed on the upper surface of the unit cells.

### SUMMARY

In such a power storage device described in JP 2022-525014 A, there is a demand for improved recyclability.

An object of the present disclosure is to provide a power storage device that is able to improve recyclability.

A power storage device according to an aspect of the present disclosure includes a plurality of power storage cells arranged in a first direction, an upper cover disposed above the power storage cells, an adhesive member that bonds the power storage cells and the upper cover to each other, and an intervention member made of rubber and interposed between the power storage cells and the upper cover. The intervention member includes a pair of intervention portions extending in the first direction and disposed at positions sandwiching the adhesive member in a second direction orthogonal to both the first direction and an up-down direction. Each of the intervention portions is provided with an intervention space extending in the first direction.

According to the present disclosure, it is possible to provide a power storage device that is able to improve recyclability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a vehicle including a power storage device according to an embodiment of the present disclosure;

FIG. 2 is a perspective view schematically illustrating the power storage device, a frame member, a front component member, and a rear component member;

FIG. 3 is a sectional view taken along line III-III in FIG. 2;

FIG. 4 is a cross-sectional view taken along line IV-IV in FIG. 3;

FIG. 5 is an enlarged view of an area indicated by a solid line V in FIG. 4; and

FIG. 6 is a sectional view taken along line VI-VI in FIG. 5.

### DETAILED DESCRIPTION OF EMBODIMENTS

An embodiment of the present disclosure will be described with reference to the drawings. In the drawings referred to below, the same or corresponding members are given the same numbers.

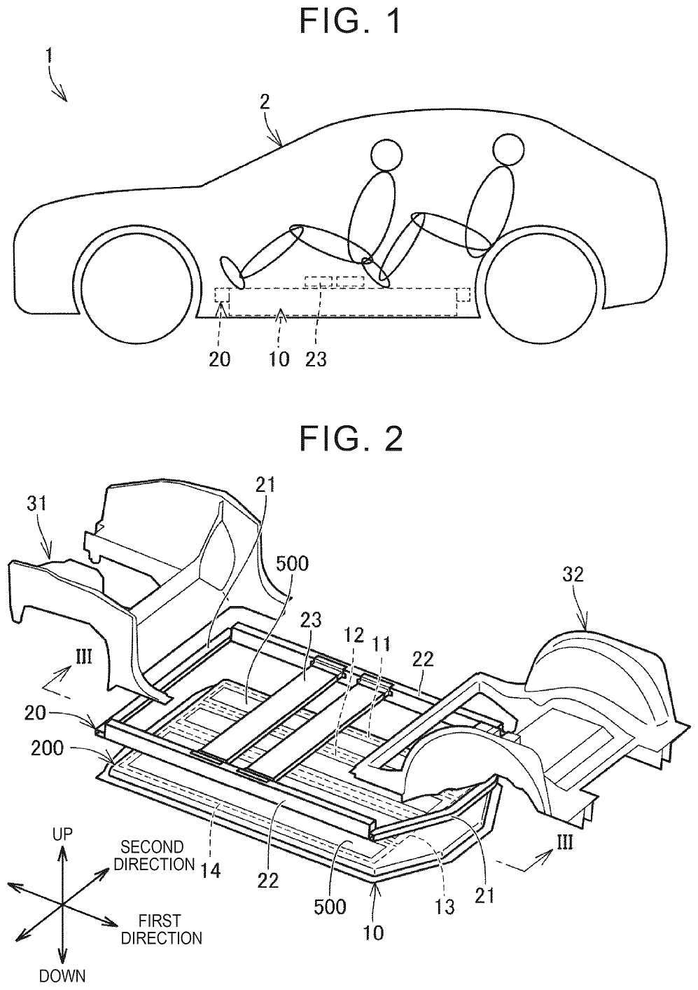

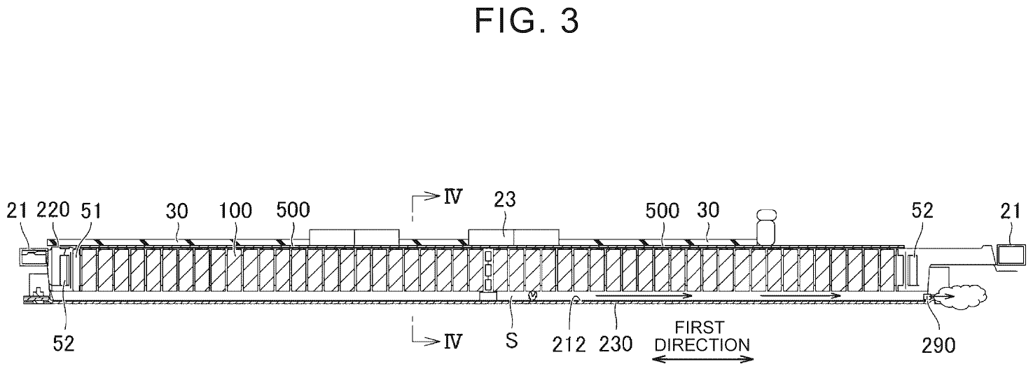

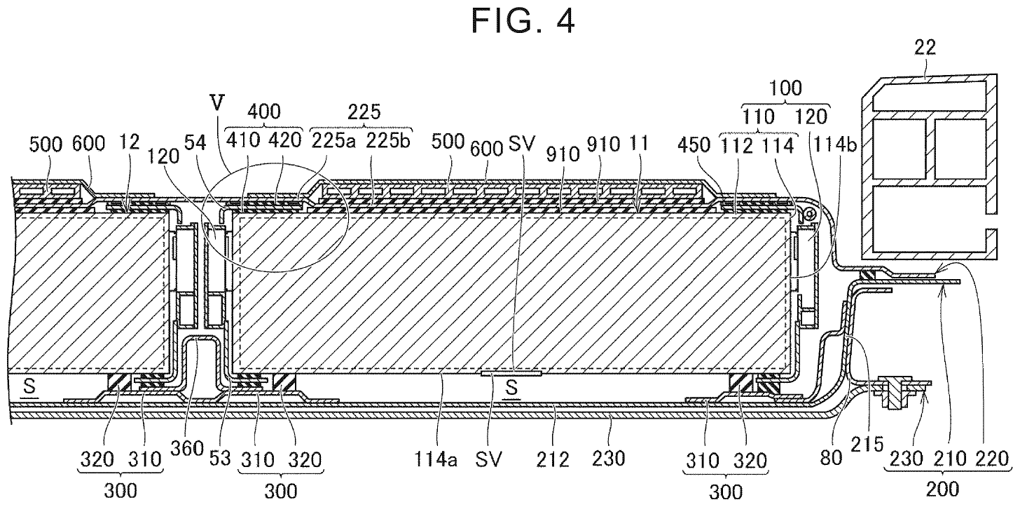

FIG. 1 is a diagram schematically illustrating a vehicle including a power storage device according to an embodiment of the present disclosure. FIG. 2 is a perspective view schematically illustrating the power storage device, a frame member, and a vehicle frame. FIG. 3 is a sectional view taken along line III-III in FIG. 2. FIG. 4 is a cross-sectional view taken along line IV-IV in FIG. 3.

As shown in FIG. 1, a vehicle 1 includes a vehicle body 2 and a power storage device 10. Examples of the vehicle 1 include a hybrid electric vehicle, a plug-in hybrid electric vehicle, a battery electric vehicle, and the like.

As shown in FIGS. 1 and 2, the vehicle body 2 includes a frame member 20, a front component member 31, and a rear component member 32. The frame member 20 is disposed at the bottom portion of the vehicle body 2. The frame member 20 has a pair of first frames 21, a pair of second frames 22, and a cross frame 23.

The first frames 21 face each other in the first direction. The first direction may be a direction parallel to the front-rear direction of the vehicle 1. In the example shown in FIG. 2, one of the first frames 21 disposed at the front has a shape extending along a second direction orthogonal to both the first direction and the up-down direction. The other of the first frames 21 disposed at the rear extends in the second direction and has a shape that protrudes rearward. The second direction may be a direction parallel to the right-left direction (width direction) of the vehicle 1.

The second frames 22 face each other in the second direction. Each of the second frames 22 has a shape extending along the first direction. The end portions of each second frame 22 in the first direction are connected to the first frames 21. The second frames 22 are formed into a substantially rectangular tubular shape, and surround the power storage device 10 together with the first frames 21.

The cross frame 23 is disposed between the first frames 21 and connects the second frames 22 to each other. The cross frame 23 constitutes, for example, a seat cross.

The front component member 31 is connected to the front portion of the frame member 20. The rear component member 32 is connected to the rear portion of the frame member 20. Each of the component members 31, 32 may be formed by aluminum die casting.

The power storage device 10 is attached to the frame member 20. As shown in FIGS. 2 and 3, the power storage device 10 is disposed below the cross frame 23. As shown in FIGS. 1 to 4, the power storage device 10 includes four power storage stacks 11 to 14, a housing 200, structural members 300, adhesive members 400, intervention members 450, coolers 500, and covering members 600. The number of the power storage stacks is not limited to four. The covering member 600 is omitted in FIG. 2.

Each of the power storage stacks 11 to 14 includes at least one power storage cell 100. In the present embodiment, each of the power storage stacks 11 to 14 includes a power storage cell group including a plurality of (for example, 50) power storage cells 100 arranged side by side along the first direction. Each of the power storage stacks 11 to 14 may further include a plurality of spacers. Each spacer is disposed between a pair of adjacent power storage cells 100 in the power storage cell group. Each of the power storage stacks 11 to 14 is formed in a rectangular parallelepiped shape that is elongated in the first direction. As shown in FIG. 2, the four power storage stacks 11 to 14 are arranged side by side along the second direction.

As shown in FIG. 3, a pair of end plates 51 is provided such that one end plate 51 is provided on each side of the plurality of power storage cells 100 and the end plates 51 sandwich the power storage cells 100 from both sides in the first direction. A monitoring unit (smart battery management) 52 is disposed on the outside of each end plate 51 in the first direction.

As shown in FIG. 4, each power storage cell 100 has a cell body 110 and a pair of external terminals 120. FIG. 4 illustrates the power storage cell 100 included in the first power storage stack 11 and a part of the power storage cell 100 included in the second power storage stack 12.

The cell body 110 includes an electrode body 112 and a cell case 114. The thickness direction of the cell body 110 corresponds to the first direction. The width direction of the cell body 110 (the direction orthogonal to both the thickness direction and the up-down direction) corresponds to the second direction.

The electrode body 112 may be made up of a wound body in which a positive electrode sheet and a negative electrode sheet are wound with a separator interposed therebetween, or may be made up of a laminate in which a positive electrode sheet and a negative electrode sheet are stacked with a separator interposed therebetween. The electrode body 112 is formed in a shape that is elongated in the second direction.

The cell case 114 houses the electrode body 112. The cell case 114 is formed in a rectangular parallelepiped shape. The cell case 114 is made of a metal such as aluminum. The cell case 114 includes a valve mounting surface 114a and terminal mounting surfaces 114b.

A safety valve SV is provided on the valve mounting surface 114a. In the present embodiment, the valve mounting surface 114a is made up of the lower surface of the cell case 114. However, the valve mounting surface 114a may be made up of the upper surface of the cell case 114.

The external terminal 120 is provided on the terminal mounting surface 114b. In the present embodiment, the terminal mounting surface 114b is made up of the side surface of the cell case 114 in the second direction. That is, each external terminal 120 protrudes in the second direction from the side surface of the cell case 114 in the second direction. One of the external terminals 120 protrudes from the side surface of the cell case 114 on one side in the second direction. The other one of the external terminals 120 protrudes from the side surface of the cell case 114 on the other side in the second direction.

The power storage device 10 may include a restraining member that restrains each of the power storage stacks 11 to 14. As shown in FIG. 4, the restraining member includes lower restraining bands 53 and upper restraining bands 54.

The lower restraining band 53 is disposed on the bottom portion of each of the power storage stacks 11 to 14. Specifically, the lower restraining band 53 restrains the lower corners of the external terminal 120 of each cell case 114 from both sides in the first direction.

The upper restraining band 54 is disposed on the top portion of each of the power storage stacks 11 to 14. Specifically, the upper restraining band 54 restrains the upper corners of the external terminal 120 of each cell case 114 from both sides in the first direction.

The housing 200 houses the power storage cells 100. In the present embodiment, the housing 200 houses the four power storage stacks 11 to 14. As shown in FIG. 4, the housing 200 has a lower case 210, an upper cover 220, and a panel member 230.

The lower case 210 is open upward. The lower case 210 has a bottom wall 212 and a peripheral wall 215.

The bottom wall 212 is located below each of the power storage stacks 11 to 14. The bottom wall 212 may be formed in a flat plate shape.

The peripheral wall 215 stands up from the peripheral edge portion of the bottom wall 212. The peripheral wall 215 has a shape that surrounds the bottom portions of the power storage stacks 11 to 14 collectively.

The upper cover 220 is disposed above the power storage cells 100. In the present embodiment, the upper cover 220 is disposed above the four power storage stacks 11 to 14. The upper cover 220 houses, together with the lower case 210, four power storage stacks 11 to 14 in a sealed state. The peripheral edge portion of the upper cover 220 is connected to the peripheral edge portion of the lower case 210 by bolts or the like via a sealing member.

As shown in FIG. 4, the upper cover 220 has an upper wall 225. The upper wall 225 is provided above at least one power storage cell 100. In the present embodiment, the upper wall 225 is provided above the four power storage stacks 11 to 14. The upper wall 225 has a top portion 225a and four recesses 225b.

The top portion 225a is formed flat. The top portion 225a overlaps in the up-down direction with the end portions of each power storage stack in the second direction.

Each recess 225b is recessed downward from the top portion 225a. Each recess 225b is formed flat. Each recess 225b is formed above the center portion of each of the power storage stacks 11 to 14 in the second direction. As shown in FIG. 4, the length of each recess 225b in the second direction is shorter than the length of the power storage cell 100 in the second direction. Each recess 225b is in contact with the upper surface of the cell case 114 via a thermally conductive adhesive 910.

The panel member 230 is provided below the lower case 210. The panel member 230 has a function of protecting the lower case 210. The panel member 230 may be formed in a flat plate shape. As shown in FIG. 4, the peripheral edge portion of the panel member 230 is connected to the lower case 210 via a bracket 80.

The structural members 300 are provided on the bottom wall 212. Each of the power storage stacks 11 to 14, the bottom wall 212, and the structural members 300 define a space S below each of the power storage stacks 11 to 14. In the present embodiment, the structural members 300 define, together with each of the power storage stacks 11 to 14 and the bottom wall 212, the space S below each of the power storage stacks 11 to 14. That is, in the present embodiment, four spaces S are formed inside the housing 200.

As shown in FIG. 3, each space S extends in the first direction. Each space S functions as a smoke exhaust path (hereinafter referred to as “smoke exhaust path S”). The smoke exhaust path S is a path for discharging gas discharged from the safety valve SV of the power storage cell 100 to the outside of the housing 200. Each smoke exhaust path S is connected to a common space within the housing 200 at an end portion of the smoke exhaust path S in the first direction.

As shown in FIG. 3, an explosion-proof valve 290 is provided on the peripheral wall 215 at a portion facing the smoke exhaust path S in the first direction. The explosion-proof valve 290 is provided in the common space within the housing 200. The explosion-proof valve 290 releases pressure in the housing 200. The explosion-proof valve 290 opens when the pressure inside the housing 200 reaches or exceeds a reference value. The explosion-proof valve 290 is made up of a check valve. As shown in FIG. 3, when gas is discharged from any of the power storage cells 100, the gas spreads in the first direction through the smoke exhaust path S and is discharged to the outside of the housing 200 through the explosion-proof valve 290.

As shown in FIG. 4, the structural members 300 contact both end portions of the valve mounting surface 114a of each power storage cell 100 in the second direction and the bottom wall 212. The structural members 300 may support each of the power storage stacks 11 to 14. In the present embodiment, the structural member 300 has a base portion 310 and a sealing portion 320.

A pair of the base portions 310 is connected to the bottom wall 212. The base portions 310 are disposed at positions facing each other in the second direction (width direction) with the safety valve SV therebetween.

Each of the sealing portions 320 is in contact with the valve mounting surface 114a of the power storage cell 100 and a corresponding one of the base portions 310. The sealing portions 320 may be made of urethane resin. The sealing portions 320 extend in the first direction. The inner surface of each of the sealing portions 320 in the second direction is in contact with the smoke exhaust path S.

As shown in FIG. 4, the power storage device 10 may include reinforcing portions 360 that reinforces the bottom wall 212. The reinforcing portion 360 is disposed between a pair of power storage stacks adjacent to each other in the second direction. Specifically, the reinforcing portion 360 is disposed between a pair of the cell bodies 110 adjacent to each other in the second direction, and below a pair of the external terminals 120 adjacent to each other in the second direction. The reinforcing portion 360 overlaps in the up-down direction with both of the external terminals 120 that face each other in the second direction.

The reinforcing portion 360 extends along the first direction. The end portions of the reinforcing portion 360 in the first direction may be in contact with the peripheral wall 215 or may be spaced apart from the peripheral wall 215. The reinforcing portion 360 is connected to the base portions 310. In the present embodiment, the reinforcing portion 360 is connected to the base portions 310 by welding or the like. That is, the reinforcing portion 360 functions as a connecting portion that connects the structural member 300 provided below one power storage stack of the pair of adjacent power storage stacks (e.g., the first power storage stack 11 and the second power storage stack 12) to the structural member 300 provided below the other power storage stack of the pair of power storage stacks. The reinforcing portion 360 has a shape that protrudes upward from the base portions 310.

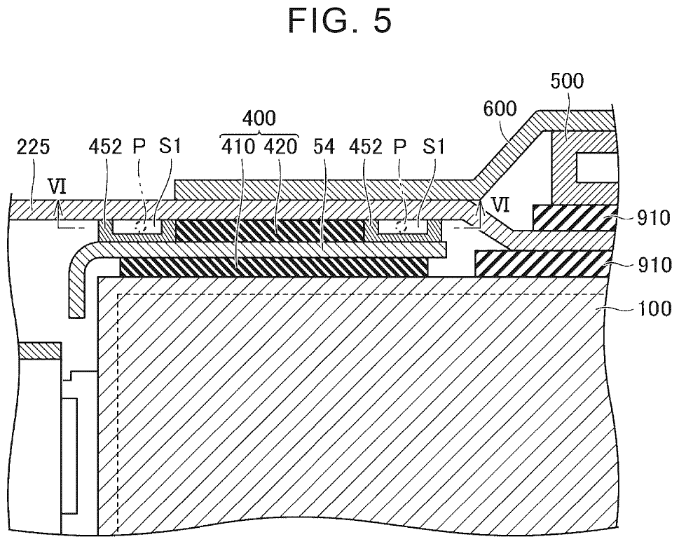

The adhesive members 400 bond the power storage cells 100 included in each of the power storage stacks 11 to 14 and the upper cover 220 to each other. As shown in FIGS. 4 and 5, the adhesive member 400 includes a lower adhesive portion 410 and an upper adhesive portion 420.

The lower adhesive portion 410 is provided between the power storage cells 100 and the upper restraining band 54.

The upper adhesive portion 420 is provided between the upper restraining band 54 and the upper cover 220. More specifically, the upper adhesive portion 420 is provided between the upper surface of the upper restraining band 54 and the lower surface of the top portion 225a.

As shown in FIG. 5, the intervention member 450 is interposed between the power storage cells 100 included in each of the power storage stacks 11 to 14 and the upper cover 220. The intervention member 450 is made of rubber. The intervention member 450 extends in the first direction. In the present embodiment, the intervention member 450 is provided between the upper restraining band 54 and the upper cover 220. However, the intervention member 450 may be provided between the upper surface of the power storage cells 100 and the upper cover 220.

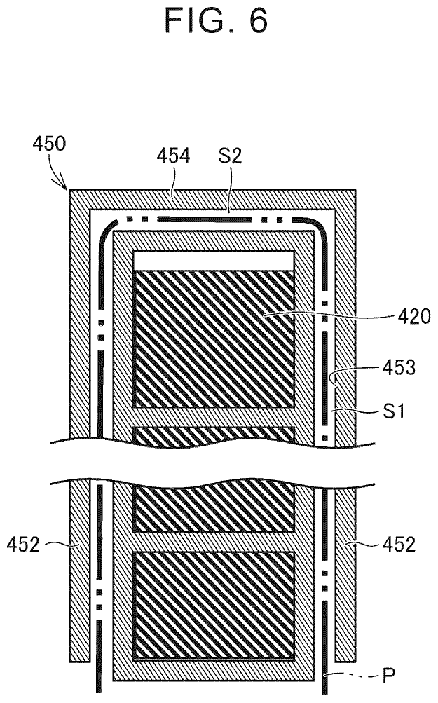

As shown in FIGS. 5 and 6, the intervention member 450 includes a pair of intervention portions 452 and a connecting portion 454.

The intervention portions 452 are provided at positions that sandwich the adhesive member 400 in the second direction. Each of the intervention portions 452 has an intervention space S1 extending in the first direction. The intervention space S1 is open upward. The intervention space S1 is closed by the top portion 225a. Each of the intervention portions 452 may be formed, for example, in a rectangular tubular shape, and the space within the intervention portion 452 may constitute the intervention space S1. Each intervention space S1 is provided at a position overlapping with the upper adhesive portion 420 in the second direction.

The connecting portion 454 connects the end portions of the intervention portions 452 in the first direction. The connecting portion 454 has a connecting space S2 that communicates with each intervention space S1. The connecting space S2 is open upward. The connecting space S2 is closed by the top portion 225a. The connecting portion 454 may be formed, for example, in a rectangular tubular shape, and the space within the connecting portion 454 may constitute the connecting space S2. The connecting space S2 is provided at a position overlapping with the upper adhesive portion 420 in the first direction.

The intervention spaces S1 and the connecting space S2 are set to a size that allows a high-strength steel wire (such as a piano wire) P to be inserted therethrough. In particular, each of the intervention portions 452 functions as a rail portion through which the steel wire P is able to be inserted. In FIGS. 5 and 6, the steel wire P is indicated by a two-dot chain line.

The cooler 500 cools at least one power storage cell 100. A cooling medium (such as water) flows through the cooler 500. As shown in FIGS. 2 to 4, the coolers 500 are provided on the upper wall 225. More specifically, the coolers 500 are provided in the recesses 225b of the upper wall 225.

Each of the coolers 500 is in thermal contact with at least one power storage cell 100 via the upper wall 225. In the present embodiment, the thermally conductive adhesive 910 extending along the first direction is provided between the cooler 500 and the recess 225b. That is, in the present embodiment, the cooler 500 is in thermal contact with each of the power storage stacks 11 to 14 via the upper wall 225 and the thermally conductive adhesive 910. Thermal contact includes a mode in which the cooler 500 contacts the power storage cell 100 only via the upper wall 225, and a mode in which the cooler 500 indirectly contacts the power storage cell 100 via a thermally conductive member (such as an adhesive or a fixing member).

The covering member 600 covers the cooler 500. The covering member 600 may be formed of a material having thermal insulation properties. The covering members 600 are omitted in FIGS. 2 and 3.

The coolers 500 and the covering members 600 form at least a part of a floor portion 30 (see FIG. 3) of a vehicle cabin. The floor portion 30 of the vehicle cabin may include, in addition to the coolers 500 and the covering members 600, floor component members (such as a cushioning member, carpet, etc.) disposed on the covering members 600. The floor component members are omitted in FIGS. 2 and 4.

In the power storage device 10 described above, when gas is discharged downward from the safety valve SV due to a short circuit or the like in any of the power storage cells 100, the gas flows into the smoke exhaust path S. Then, the gas that has flowed into the smoke exhaust path S spreads in the first direction and is discharged from the housing 200 through the explosion-proof valve 290 as shown in FIG. 3. This restrains the contents (so-called debris) of the power storage cell 100 included in the gas from bonding to the external terminal 120 of the power storage cell 100 and the like.

Further, since this power storage device 10 is equipped with the intervention members 450, by inserting, for example, a high-strength steel wire (such as a piano wire) P into each of the intervention spaces S1 and the connecting space S2, and moving the steel wire P in the first direction, the intervention portions 452, the connecting portion 454, and the upper adhesive portion 420 are cut. Therefore, it becomes possible to easily remove the upper cover 220 from the power storage device 10. Therefore, recyclability is improved.

It will be understood by a person skilled in the art that the exemplary embodiments described above are examples of the following aspects.

### First Aspect

A power storage device includes a plurality of power storage cells arranged in a first direction, an upper cover disposed above the power storage cells, an adhesive member that bonds the power storage cells and the upper cover to each other, and an intervention member made of rubber and interposed between the power storage cells and the upper cover. The intervention member includes a pair of intervention portions extending in the first direction and disposed at positions sandwiching the adhesive member in a second direction orthogonal to both the first direction and an up-down direction, and each of the intervention portions is provided with an intervention space extending in the first direction.

In this power storage device, by inserting, for example, a high-strength steel wire (such as a piano wire) into each intervention space, and moving the steel wire in the first direction, the intervention portion and the adhesive member are cut. Therefore, it becomes possible to easily remove the upper cover from the power storage device. Therefore, recyclability is improved.

### Second Aspect

The power storage device according to the first aspect further includes an upper restraining band that restrains the power storage cells from both sides in the first direction. The upper restraining band is positioned above the power storage cells. The adhesive member includes a lower adhesive portion provided between the power storage cells and the upper restraining band, and an upper adhesive portion provided between the upper restraining band and the upper cover. Each of the intervention spaces is provided at a position overlapping with the upper adhesive portion in the second direction.

In this aspect, since the upper adhesive portion is able to be cut by the steel wire, the upper cover is able to be removed while maintaining the adhesive state between the upper restraining band and the power storage cells by the lower adhesive portion.

### Third Aspect

In the power storage device according to the second aspect, the intervention member is provided between the upper restraining band and the upper cover.

### Fourth Aspect

In the power storage device according to any one of the first aspect to the third aspect, the intervention member further includes a connecting portion that connects end portions of the intervention portions in the first direction, and the connecting portion is provided with a connecting space that communicates with each of the intervention spaces.

### Fifth Aspect

In the power storage device according to the fourth aspect, each of the intervention spaces and the connecting space are open upward.

The embodiment disclosed this time should be considered to be illustrative in all respects and not restrictive. The scope of the present disclosure is indicated by the claims rather than the description of the embodiment described above, and all changes within the meaning and scope equivalent to the claims are included.

What is claimed is:

1. A power storage device comprising:
a plurality of power storage cells arranged in a first direction;
an upper cover disposed above the power storage cells;
an adhesive member that bonds the power storage cells and the upper cover to each other; and
an intervention member made of rubber and interposed between the power storage cells and the upper cover, wherein the intervention member includes a pair of intervention portions extending in the first direction and disposed at positions sandwiching the adhesive member in a second direction orthogonal to both the first direction and an up-down direction, and
each of the intervention portions is provided with an intervention space extending in the first direction.

2. The power storage device according to claim 1, further comprising an upper restraining band that restrains the power storage cells from both sides in the first direction, wherein:
the upper restraining band is positioned above the power storage cells;
the adhesive member includes
a lower adhesive portion provided between the power storage cells and the upper restraining band, and
an upper adhesive portion provided between the upper restraining band and the upper cover; and
each of the intervention spaces is provided at a position overlapping with the upper adhesive portion in the second direction.

3. The power storage device according to claim 2, wherein the intervention member is provided between the upper restraining band and the upper cover.

4. The power storage device according to claim 1, wherein:
the intervention member further includes a connecting portion that connects end portions of the intervention portions in the first direction; and
the connecting portion is provided with a connecting space that communicates with each of the intervention spaces.

5. The power storage device according to claim 4, wherein each of the intervention spaces and the connecting space are open upward.
